(19) United States
(12) Patent Application Publication
(10) Pub. No.: US 2026/0307477 A1
(43) Pub. Date: Oct. 8, 2026

(54) DISCONNECTOR CONTROL APPARATUS AND METHOD FOR SUPPORTING DRIVING, AND VEHICLE AND STORAGE MEDIUM INCLUDING SAME

(71) Applicants: Hyundai Motor Company, Seoul (KR); Kia Corporation, Seoul (KR)

(72) Inventors: Jun Han KANG, Hwaseong-Si (KR); Young II KIM, Hwaseong_Si (KR); Jung Mo KOO, Hwaseong-Si (KR); Kyoung Soo WE, Hwaseong-Si (KR); Hye Yeon LEE, Hwaseong-Si (KR); Ji Hun BYUN, Hwaseongi-si (KR); Moon Joon KIM, Hwaseong-Si (KR); Ik Jin UM, Hwaseong-Si (KR); Jae Seong LEE, Hwaseong_Si (KR)

(73) Assignees: Hyundai Motor Company, Seoul (KR); Kia Corporation, Seoul (KR)

(21) Appl. No.: 19/300,253

(22) Filed: Aug. 14, 2025

(30) Foreign Application Priority Data
Apr. 2, 2025 (KR) 10-2025-0042641

(51) Int. Cl. B60K 23/08; B60L 15/20

(52) U.S. Cl. CPC B60K 23/08; B60L 15/20; B60K 2023/0858

(57) ABSTRACT

A disconnector control apparatus for supporting driving, the disconnector control apparatus includes a controller configured to receive driving data of a vehicle configured to switch between two-wheel drive (2WD) and four-wheel drive (4WD) depending on whether a disconnector is engaged, and to control whether the disconnector of the vehicle is to be engaged according to disconnector control data obtained by applying the driving data to a disconnector control logic. The disconnector control logic is configured to determine whether the disconnector is to be engaged according to road surface severity of a road surface of the vehicle based on the driving data.

### CROSS-REFERENCE TO RELATED APPLICATIONS

The present application claims benefit of priority to Korean Patent Application No. 10-2025-0042641 filed on April 2, 2025 in the Korean Intellectual Property Office, the disclosure of which is incorporated herein by reference in its entirety.

### BACKGROUND

### Field

The present disclosure relates to a disconnector control apparatus and method for supporting driving, and a vehicle and storage medium including the same.

### Description of Related Art

Generally, in four-wheel drive (4WD) vehicles, front and rear drive shafts are mechanically connected to transmit driving force, making high-speed driving infeasible and causing unfavorable fuel efficiency.

Recently, due to the demand of the global market for eco-friendliness and high fuel efficiency, electric four-wheel drive (e-4WD) systems have been applied to eco-friendly vehicles such as hybrid electric vehicles (HEVs), plug-in hybrid electric vehicles (PHEVs), and electric vehicles (EVs), or general internal combustion engine vehicles.

An e-4WD system may provide a 4WD function by driving auxiliary drive wheels (secondary drive wheels) (for example, rear wheels) with a motor, separately from main drive wheels (for example, front wheels).

An e-4WD vehicle may selectively perform two-wheel drive (2WD) driving and 4WD driving. In the present process, a disconnector may be used to switch between 2WD and 4WD. The disconnector may connect or disconnect an auxiliary driving source (secondary driving source) of the vehicle, such as a motor, to or from a wheel shaft of the vehicle.

### SUMMARY

According to an exemplary embodiment of the present disclosure, a disconnector control apparatus and method for supporting driving, and a vehicle and storage medium including the same, may efficiently improve overall driving energy efficiency on a road surface, and may stably secure driving force (and/or secure additional stability according to AWD control), even when road surface severity of the road surface varies widely, efficiently reducing a possibility of a vehicle slipping and/or becoming stuck.

According to an aspect of the present disclosure, there is provided a disconnector control apparatus for supporting driving, the disconnector control apparatus including a controller configured to receive driving data of a vehicle configured to switch between two-wheel drive (2WD) and four-wheel drive (4WD) depending on whether a disconnector is engaged, and to control whether the disconnector of the vehicle is to be engaged according to disconnector control data obtained by applying the driving data to a disconnector control logic. The disconnector control logic may be configured to determine whether the disconnector is to be engaged according to road surface severity of a road surface of the vehicle based on the driving data.

For example, the disconnector control logic may be configured so that when the road surface severity is less than a disconnector control reference, the controller is configured to control the disconnector to be in a disengaged state to perform control in 2WD, and when the road surface severity is more than the disconnector control reference, the controller is configured to control the disconnector to be in an engaged state to perform control in 4WD.

For example, the disconnector control reference may include a first disconnector control reference and a second disconnector control reference higher than the first disconnector control reference. The disconnector control logic may be configured so that when the road surface severity is switched from a level higher than the first disconnector control reference to a level lower than the first disconnector control reference, the controller is configured to switch the disconnector from the engaged state to the disengaged state to switch from 4WD to 2WD, and when the road surface severity is switched from a level lower than the second disconnector control reference to a level higher than the second disconnector control reference, the controller is configured to switch the disconnector from the disengaged state to the engaged state to switch from 2WD to 4WD.

For example, the road surface severity may include at least one of a low-friction level of the road surface and an off-road level of the road surface. The disconnector control logic may be configured to determine whether the disconnector is to be engaged according to at least one of the low-friction level and the off-road level.

For example, the disconnector control logic may be configured to determine the disconnector control reference according to one of the low-friction level and the off-road level, and to allow the controller to control whether the disconnector is to be engaged according to a comparison relationship between the other one of the low-friction level and the off-road level and the disconnector control reference.

For example, the disconnector control logic may be configured to determine a wheel slip ratio, based on the driving data, to determine the low-friction level, based on the wheel slip ratio, and to determine the off-road level, based on the driving data.

For example, the controller may be configured to generate off-road-type data of the vehicle. The off-road-type data may include at least two of snow-type data corresponding to a snow road, sand-type data corresponding to a sand road, and mud-type data corresponding to a mud road. The controller may be configured to store a plurality of disconnector control reference sets. The plurality of disconnector control reference sets may include at least two of a snow-type disconnector control reference set, a sand-type disconnector control reference set, and a mud-type disconnector control reference set. The disconnector control logic may be configured to select one of the plurality of disconnector control reference sets according to the off-road-type data, and to determine whether the disconnector is to be engaged according to the low-friction level and the off-road level in the selected disconnector control reference set.

For example, the controller may be configured to generate off-road-type data of the vehicle. The disconnector control logic may be configured to determine whether the disconnector is to be engaged according to the off-road-type data and the road surface severity.

For example, the controller may be configured to receive the driving data from a sensor unit. The driving data may include at least one of a speed of the vehicle, an acceleration of the vehicle, a yaw rate of the vehicle, a yaw acceleration of the vehicle, a steering angle of the vehicle, the number of rotations of a wheel of the vehicle, a torque of the vehicle, and an acceleration input value of the vehicle.

For example, the disconnector control logic may be configured to periodically determine whether the disconnector is to be engaged at a predetermined determination cycle. The determination cycle may be less than 10 seconds.

For example, the disconnector control logic may be configured to selectively control whether the disconnector is to be engaged depending on whether an off-road driving mode is used. The controller may be configured to determine whether the off-road driving mode is used based on a manual method according to an input or an automatic method based on the driving data.

According to another aspect of the present disclosure, there is provided a disconnector control method for supporting driving, the disconnector control method including storing a disconnector control logic of a vehicle based on road surface severity of a road surface of the vehicle configured to switch between 2WD and 4WD depending on whether a disconnector is engaged, receiving driving data of the vehicle, and applying the driving data to the disconnector control logic to control whether the disconnector of the vehicle is to be engaged.

For example, the road surface severity may include at least one of a low-friction level of the road surface and an off-road level of the road surface. The disconnector control logic may be configured to determine whether the disconnector is to be engaged according to at least one of the low-friction level and the off-road level.

For example, the disconnector control logic may be configured to determine a disconnector control reference according to one of the low-friction level and the off-road level, to control the disconnector to be in a disengaged state when the other one of the low-friction level and the off-road level is lower than the disconnector control reference, and to control the disconnector to be in an engaged state when the other one of the low-friction level and the off-road level is higher than the disconnector control reference.

For example, the disconnector control logic may be configured to determine whether the disconnector is to be engaged according to an off-road-type data and the road surface severity.

According to another aspect of the present disclosure, there is provided a storage medium having recorded thereon one or more programs including instructions for executing the disconnector control method for supporting driving.

According to another aspect of the present disclosure, there is provided a vehicle including a controller including a processor and a storage medium having recorded thereon one or more programs configured to be executed by the processor. The one or more programs may include instructions for executing the disconnector control method for supporting driving.

According to another aspect of the present disclosure, there is provided a vehicle including a disconnector configured to switch between 2WD and 4WD depending on whether the disconnector is engaged, a sensor unit configured to detect driving data, and a controller configured to control whether the disconnector is to be engaged according to disconnector control data obtained by applying the driving data to a disconnector control logic. The disconnector control logic may be configured to determine whether the disconnector is to be engaged according to road surface severity of a road surface of the vehicle based on the driving data.

For example, the road surface severity may include at least one of a low-friction level of the road surface and an off-road level of the road surface. The disconnector control logic may be configured to determine whether the disconnector is to be engaged according to at least one of the low-friction level and the off-road level.

For example, the disconnector control logic may be configured to determine a disconnector control reference according to one of the low-friction level and the off-road level, to control the disconnector to be in a disengaged state when the other one of the low-friction level and the off-road level is lower than the disconnector control reference, and to control the disconnector to be in an engaged state when the other one of the low-friction level and the off-road level is higher than the disconnector control reference.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1 and 2 are diagrams illustrating a disconnector control apparatus for supporting driving and a vehicle, according to an exemplary embodiment of the present disclosure;

FIG. 3 is a block diagram more specifically illustrating a controller and a sensor unit of a disconnector control apparatus and method for supporting driving, and a vehicle and storage medium, according to an exemplary embodiment of the present disclosure;

FIG. 4 is a diagram illustrating control whether a disconnector is to be engaged according to road surface severity in a disconnector control apparatus and method for supporting driving, and a vehicle and storage medium, according to an exemplary embodiment of the present disclosure;

FIG. 5 is a flowchart illustrating a disconnector control method for supporting driving according to an exemplary embodiment of the present disclosure;

FIG. 6 is a flowchart illustrating an operation based on a disconnector control reference in a disconnector control apparatus and method for supporting driving, and a vehicle and storage medium, according to an exemplary embodiment of the present disclosure;

FIG. 7 is a flowchart illustrating an operation in which a disconnector control reference is determined according to off-road-type data (and/or a low-friction level of road surface severity) in a disconnector control apparatus and method for supporting driving, and a vehicle and storage medium, according to an exemplary embodiment of the present disclosure.

FIG. 8 is a graph illustrating an operation in which a disconnector control reference is determined according to off-road-type data in a disconnector control apparatus and method for supporting driving, and a vehicle and storage medium, according to an exemplary embodiment of the present disclosure;

FIG. 9 is a diagram illustrating a plurality of disconnector control reference sets in a disconnector control apparatus and method for supporting driving, and a vehicle and storage medium, according to an exemplary embodiment of the present disclosure;

FIG. 10 is a flowchart illustrating determination of a low-friction level of road surface severity, based on a wheel slip ratio, in a disconnector control apparatus and method for supporting driving, and a vehicle and storage medium including the same, according to an exemplary embodiment of the present disclosure; and

FIG. 11 is a flowchart illustrating an operation based on first and second disconnector control reference (hysteresis) in a disconnector control apparatus and method for supporting driving, and a vehicle and storage medium, according to an exemplary embodiment of the present disclosure.

### DETAILED DESCRIPTION

Various modifications may be made to the example embodiments. Here, the example embodiments are not construed as limited to the disclosure and should be understood to include all changes, equivalents, and replacements within the idea and the technical scope of the disclosure.

The terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component. The term “and/or” may include combinations of a plurality of related described items or any of a plurality of related described items.

The terms used herein is for describing example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in the present code, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those which would be generally understood by one of ordinary skill in the art. Terms defined in dictionaries generally used should be construed to have meanings matching contextual meanings in the related art and are not to be construed as having an ideal or excessively formal meaning, unless otherwise defined herein.

As used herein, vehicles (including electric vehicles) refers to various vehicles transporting a transported object such as a person, animal, or object from a starting point to a destination. Such vehicles are not limited to vehicles driving on roads or tracks.

Hereinafter, exemplary embodiments of the present disclosure will be described in more detail with reference to the accompanying drawings.

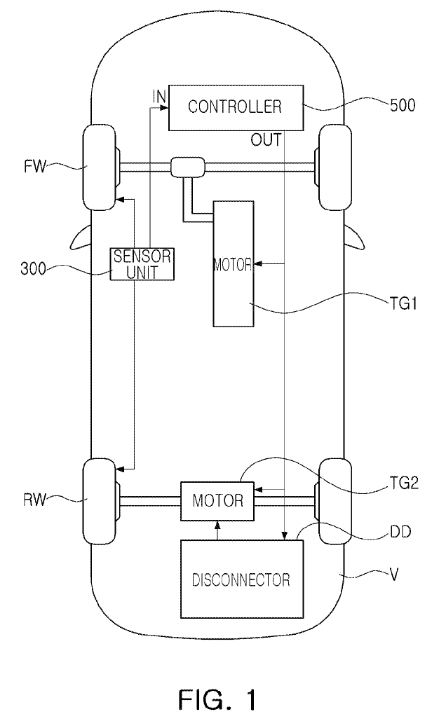

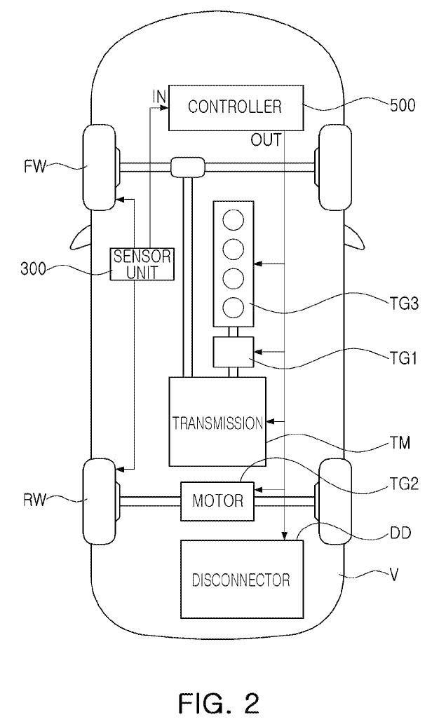

Referring to FIGS. 1 and 2, a vehicle V may include a first motor TG1 providing a torque to a front wheel FW and a second motor TG2 providing a torque to a rear wheel RW. The vehicle V may be driven in all-wheel drive (AWD) in a state of being controlled in four-wheel drive (4WD). AWD may be a driving method that allows the torque of the front wheel FW and the torque of the rear wheel RW to be independently determined, and may be a driving method that allows a torque distribution ratio between the front wheel FW and the rear wheel RW to be flexibly determined.

Referring to FIG. 1, the vehicle V may be an electric vehicle not including an engine. Referring to FIG. 2, the vehicle V may be a hybrid electric vehicle (including a plug-in hybrid electric vehicle) including an engine TG3 and a transmission TM. Configurations (for example, the number, position, connection relationship, or the like) of the first and second motors TG1, TG2 are not limited. For example, at least one of the first and second motors TG1, TG2 may include a converter (for example, an inverter) for conversion between direct current (DC) and alternating current (AC), and may include a battery such as a high-voltage battery pack configured for storing energy and being charged/discharged.

Referring to FIGS. 1, 2,and 3, the vehicle V according to an exemplary embodiment of the present disclosure may include a disconnector DD, a sensor unit 300, and a controller 500. For example, the controller 500 may include a vehicle control unit (VCU) and/or a microcontroller unit (MCU), and may be at least a portion of a disconnector actuator system (DAS).

The disconnector DD may be configured to switch between two-wheel drive (2WD) and 4WD of the vehicle V depending on whether the disconnector DD is engaged. One (for example, the front wheel) of the front wheel FW and the rear wheel RW of the vehicle V, may be a main drive wheel which is configured for being driven at all times, and the other one (for example, the rear wheel) may be an auxiliary drive wheel. Depending on whether the disconnector DD is engaged, whether the auxiliary drive wheel is configured for being driven may be determined, and switching between 2WD and 4WD of the vehicle V may be performed. For example, the disconnector DD may include a clutch positioned on a driveshaft of the rear wheel RW (or a driveshaft of the front wheel FW), and may include an actuator operating the clutch, but the present disclosure is not limited thereto.

For example, when the disconnector DD is in an engaged state, the driveshaft of the rear wheel RW and the second motor TG2 may be connected to each other (in a torque-transmittable structure), or the driveshaft of the front wheel FW and the first motor TG1 may be connected to each other. Accordingly, the vehicle V may be controlled in 4WD. For example, the controller 500 may transmit a signal for engagement to the actuator, and thus the clutch may control the disconnector DD so that the driveshaft and a corresponding motor are connected to each other.

For example, when the disconnector DD is in a disengaged state, the driveshaft of the rear wheel RW and the second motor TG2 may be disconnected from each other in a torque-untransmittable structure, or the driveshaft of the front wheel FW and the first motor TG1 may be disconnected from each other. Accordingly, the vehicle V may be controlled in 2WD. For example, the controller 500 may transmit a signal for disengagement to the actuator, and thus the clutch may control the disconnector DD so that the driveshaft and a corresponding motor are disconnected from each other.

The sensor unit 300 may detect (for example, monitor, detect at all times) driving data. For example, the driving data may include at least one of a speed (a sensing value of a vehicle speed sensor 302 of the sensor unit 300) of the vehicle V, an acceleration (a sensing value of an acceleration sensor 305 of the sensor unit 300) of the vehicle, a yaw rate (a sensing value of a yaw rate sensor 301 of the sensor unit 300) of the vehicle V, a yaw acceleration (a sensing value of a yaw acceleration sensor 304 of the sensor unit 300) of the vehicle V, a steering angle (a sensing value of a steering angle sensor 307 of the sensor unit 300) of the vehicle V, the number of rotations (a sensing value of a wheel speed sensor 303 of the sensor unit 300) of a wheel (the front wheel FW and/or the rear wheel RW) of the vehicle V, a torque (a sensing value of a torque sensor 306 of the sensor unit 300) of the vehicle V, and an acceleration input value (a sensing value of an APS sensor 308 of the sensor unit 300) of the vehicle V. The sensor unit 300 may include at least one of the vehicle speed sensor 302, the acceleration sensor 305, the yaw rate sensor 301, the yaw acceleration sensor 304, the steering angle sensor 307, the wheel speed sensor 303, the torque sensor 306, and the APS sensor 308.

The torque of the vehicle V may include a torque of the engine (or a motor) and/or a torque of the wheel (the front wheel FW and/or the rear wheel RW). The acceleration of the vehicle V may include a longitudinal acceleration and/or a lateral acceleration of the vehicle V. The yaw rate may be a rate at which an attitude of the vehicle V rotates in a yaw direction, and the yaw direction may be a direction surrounding a direction (for example, a direction of gravity) in which the vehicle V faces the ground. An APS of the APS sensor 308 may be an accelerator pedal sensor.

For example, while the disconnector DD is in an engaged state (corresponding to 4WD), the controller 500 may receive (IN) the driving data from the sensor unit 300, and may be configured for controlling AWD, based on the driving data, controlling torques of the first and second motors TG1 and TG2.

For example, to control AWD, the controller 500 may store in advance a vehicle stability control logic (for example, a turning control logic, a traction control system (TCS), or an electronic stability program (ESP), or a performance-fuel efficiency optimization control logic, may independently determine the torque of the first motor TG1 and the torque of the second motor TG2 in real time according to the vehicle stability control logic and/or the performance-fuel efficiency optimization control logic, and may flexibly control the first and second motors TG1 and TG2 according to the determined torques. Accordingly, at least one of performance, fuel efficiency, and stability of the vehicle V may be improved in terms of overall optimization.

For example, the controller 500 may be configured to determine a torque distribution ratio between the first and second motors TG1 and TG2 by controlling AWD, controlling a front and rear torque distribution ratio. The controller 500 may change the front and rear torque distribution ratio (together with possibly changing a total torque) by reducing or increasing the torque of one of the first and second motors TG1 and TG2, and may also change the front and rear torque distribution ratio while maintaining the total torque by complementarily changing the torques of the first and second motors TG1 and TG2 with respect to each other.

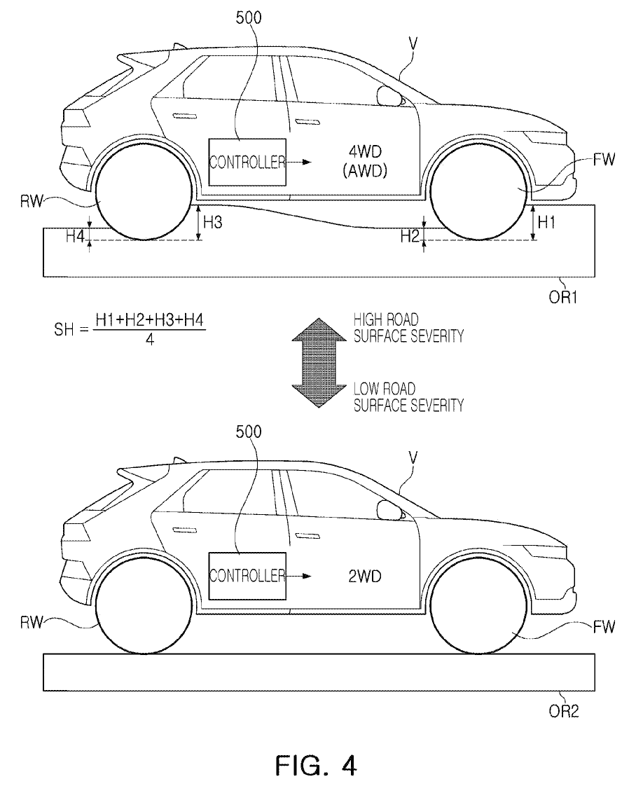

Referring to FIG. 4, the vehicle V may drive on road surfaces OR1 and OR2. For example, the road surfaces OR1 and OR2 may include an off-road. As road surface severity of the road surfaces OR1 and OR2 increases, the road surfaces OR1 and OR2 may be more likely to be off-road. For example, as compared to the road surface OR2 having lower road surface severity, the road surface OR1 having higher road surface severity may be more likely to be off-road.

For example, the road surface severity may include at least one of a low-friction level and an off-road level. As the road surfaces OR1 and OR2 have lower friction (that is, the low-friction level increases), the vehicle V may be more likely to slip on the road surfaces OR1 and OR2, and the vehicle V may have lower attitude stability.

The off-road may include a road surface (for example, a snowy road, mud road, or sandy road) other than a paved road, and may also include a road with poor surface conditions. Unlike an ideal road, road surface severity of the off-road may vary widely. An off-road level which may be included in the road surface severity may be defined as a measure indicating how far characteristics of a corresponding road surface deviate from those of the ideal road.

For example, the characteristics may include a level deviation SH of a road surface and/or a degree of change in the level deviation of the road surface according to a torque of the wheel, and the off-road level may include the level deviation SH of the road surface and/or the degree of change in the level deviation of the road surface according to the torque of the wheel. The level deviation SH of the road surface may be an average of a front level H1 and a rear level H2 of the front wheel FW and a front level H3 and a rear level H4 of the rear wheel RW. A reference for the levels H1, H2, H3, and H4 may be a lowest level of the road surface, but the present disclosure is not limited thereto. For example, an off-road level (included in the road surface severity) of the road surface OR1 having a large level deviation SH may be higher than an off-road level (included in the road surface severity) of the road surface OR2 having a small level deviation SH.

As the road surface severity (for example, the level deviation of the road surface and/or the degree of change in the level deviation of the road surface according to the torque of the wheel) of the road surfaces OR1 and OR2 increases, a possibility of the front wheel FW and/or the rear wheel RW of the vehicle V becoming stuck at a specific point (for example, a point having a steepest level gradient) on the road surfaces OR1 and OR2 may increase.

A disconnector control apparatus for supporting driving and a controller 500 of a vehicle V according to an exemplary embodiment of the present disclosure may be configured to receive (IN in FIGS. 1 and 2) driving data from a sensor unit (300 in FIGS. 1 and 2), and to control whether a disconnector is to be engaged according to disconnector control data (OUT in FIGS. 1 and 2) obtained by applying the driving data to a disconnector control logic. The disconnector control logic may be configured to determine whether the disconnector is to be engaged (for example, 4WD (AWD being possible) or 2WD) according to road surface severity (for example, high or low) of road surfaces OR1 and OR2 of the vehicle V based on the driving data.

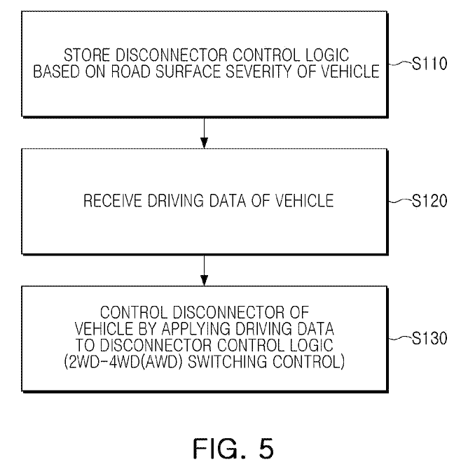

Referring to FIGS. 4 and 5, a disconnector control method for supporting driving according to an exemplary embodiment of the present disclosure may include storing, by a controller 500, a disconnector control logic of a vehicle V based on road surface severity of a road surface OR1 or OR2 of the vehicle V (S110), receiving, by the controller 500, driving data of the vehicle V (S120), and controlling (for example, switch-controlling), by the controller 500, whether a disconnector of the vehicle V is to be engaged (for example, 4WD (AWD being possible) or 2WD) by applying the driving data to the disconnector control logic (S130).

For example, a road surface OR1 may have high road surface severity (for example, a low-friction level and/or an off-road level), and thus the controller 500 may be configured for controlling a disconnector (DD in FIGS. 1 and 2) to be in an engaged state (and control the vehicle in 4WD), stably securing driving force of the vehicle V (and/or securing additional stability according to AWD control). Accordingly, a possibility of the vehicle V slipping (related to the low-friction level) and/or a possibility of the vehicle becoming stuck (related to the off-road level) may be reduced.

For example, a road surface OR2 may have low road surface severity, and thus the controller 500 may be configured for controlling (and control in 2WD) the disconnector (DD in FIGS. 1 and 2) to be in a disengaged state. Accordingly, driving energy efficiency of the vehicle V may be improved.

Accordingly, the disconnector control apparatus and vehicle V for supporting driving according to an exemplary embodiment of the present disclosure may efficiently improve overall driving energy efficiency on the road surfaces OR1 and OR2, and may stably secure driving force (and/or secure additional stability according to AWD control), even when road surface severity of the road surfaces OR1 and OR2 varies widely, efficiently reducing a possibility of a vehicle slipping and/or becoming stuck.

For example, the controller 500 may be configured for controlling whether the disconnector is to be engaged in advance through feedforward before the vehicle V actually slips or becomes stuck so that the controller may control whether the disconnector (DD in FIGS. 1 and 2) is to be engaged early to prevent loss of vehicle stability/performance during a mechanical engagement period of time (for example, 0.5 seconds) of the disconnector.

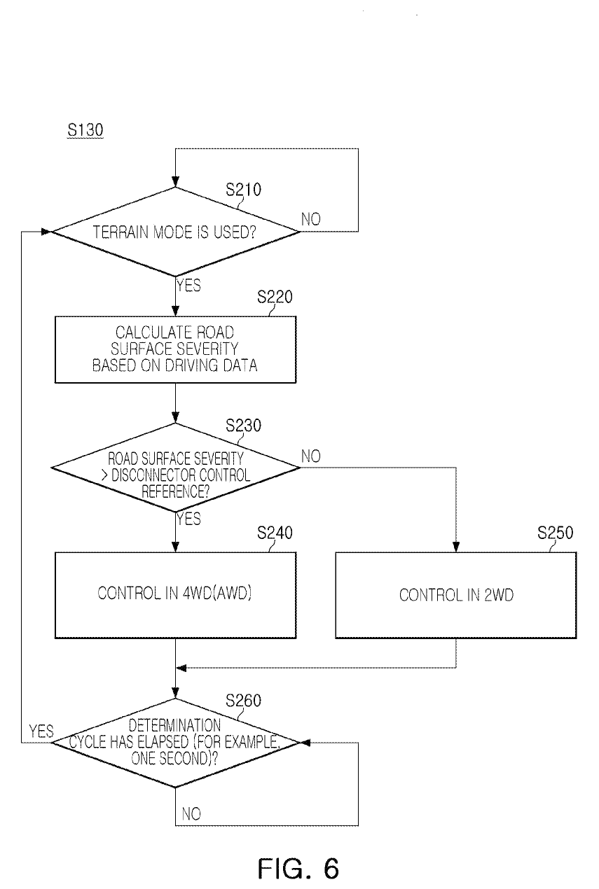

Referring to FIGS. 4 and 6, the disconnector control logic may be configured to determine the road surface severity, based on the driving data (S220). For example, the disconnector control logic may include a logic (for example, equations for determination) for determining the road surface severity.

For example, to improve accuracy of determining (or estimating) the road surface severity from the driving data, driving experiments of the vehicle (prototype) on various road surfaces (for example, off-road) may be conducted cumulatively. In the present process, the controller 500 may gradually optimize the logic (which may be included in the disconnector control logic) for determining the road surface severity from the driving data (for example, optimizing coefficients and constants of equations for determination).

For example, the controller 500 may be configured to determine intermediate data between the driving data and the road surface severity, further improving accuracy of the road surface severity. For example, the intermediate data may include a slip ratio of a wheel (front wheel FW and/or rear wheel RW) and/or a friction coefficient of a road surface (for example, off-road). The slip ratio may be defined as a value obtained by dividing a difference value between the number of rotations of the wheel (front wheel FW and/or rear wheel RW) and a speed of the vehicle V by the number of rotations or the speed. The friction coefficient may be defined by an equation different from the slip ratio, and may correspond to a reciprocal of the low-friction level.

For example, in a situation in which the vehicle V may become stuck, load of the wheel (front wheel FW and/or rear wheel RW) may decrease, and the slip ratio may increase according to the decrease in the load. The slip ratio may also increase when the friction coefficient decreases. As a value obtained by dividing the slip ratio by the friction coefficient increases, the road surface severity may further increase. Accordingly, the controller 500 may accurately estimate the road surface severity, based on at least one of the slip ratio and the friction coefficient.

The disconnector control logic may be configured to selectively control whether the disconnector is to be engaged depending on whether an off-road driving mode (for example, a manual terrain mode or an automatic terrain mode) is used (for example, “Yes/No” in S210). The controller 500 may be configured to determine whether the off-road driving mode (for example, a manual terrain mode or an automatic terrain mode) is used based on a manual method according to an input (for example, a method of setting a mode through a manual input by a driver) or an automatic method based on the driving data (for example, a method of setting a mode by automatically determining whether road surface severity or a minimum reference of the road surface severity is reached).

Accordingly, a possibility that another control logic (for example, a control logic used when a vehicle is not driving on an off-road) conflicts with the disconnector control logic may be preemptively prevented. For example, the controller 500 may deactivate the off-road driving mode (for example, a terrain mode) when the vehicle V is driving on a paved road, and may activate the off-road driving mode (for example, the terrain mode) when the vehicle V is driving on the off-road.

For example, an off-road level which may be included in the road surface severity may correspond to an automatic off-road (for example, terrain) determination value of the off-road driving mode (for example, an automatic terrain mode).

The disconnector control logic may be configured to control the disconnector to be in a disengaged state to perform control in 2WD (S250) when the road surface severity is less than a disconnector control reference (“No” in S230), and to control the disconnector to be in an engaged state to perform control in 4WD (or AWD being possible) (S240) when the road surface severity is more than the disconnector control reference (“Yes” in S230). That is, the disconnector control logic may be configured so that the controller 500 is more likely to control the disconnector to be in an engaged state (corresponding to 4WD control) when the road surface severity is more than the disconnector control reference (“Yes” in S230), as compared to when the road surface severity is less than the disconnector control reference (“No” in S230).

The disconnector control logic may be configured to periodically determine whether the disconnector is to be engaged at a predetermined determination cycle (S260). Accordingly, accuracy and reliability of control whether the disconnector is to be engaged may be further improved. For example, the determination cycle may be less than 10 seconds (for example, 1 second), but the present disclosure is not limited thereto. A lower limit of the determination cycle (for example, 0.1 second or 0.01 second) may vary depending on the performance of the controller 500.

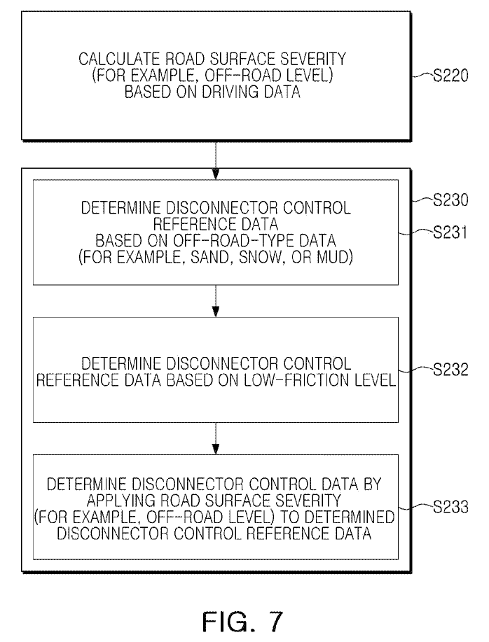

Referring to FIGS. 6 and 7, the disconnector control logic may be configured to determine the disconnector control reference according to off-road-type data (for example, SAND, SNOW, or MUD) of the vehicle V (S231), and to determine whether the disconnector is to be engaged according to the off-road-type data (for example, SAND, SNOW, or MUD) and the road surface severity (S233). That is, the disconnector control logic may be configured to determine whether the disconnector is to be engaged according to the off-road-type data (for example, SAND, SNOW, or MUD) and the road surface severity. Accordingly, accuracy and reliability of control whether the disconnector is to be engaged may be further improved. For example, the controller 500 may define the off-road-type data of the vehicle V (for example, generate the off-road-type data according to an off-road control logic such as a terrain mode, or generate the off-road-type data through a manual input by a driver), before the driving data is received.

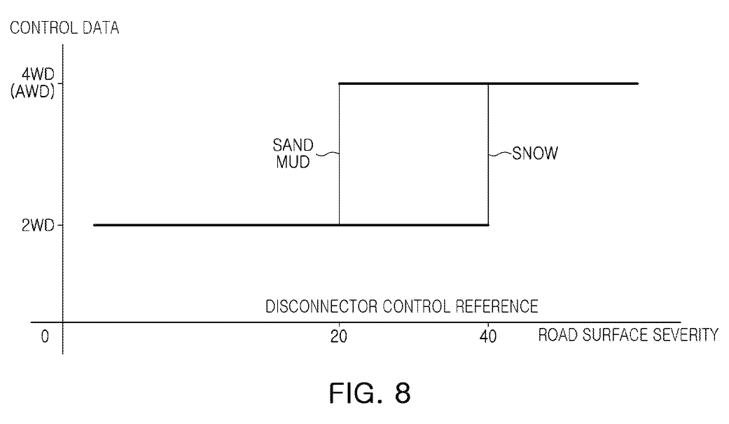

Referring to FIGS. 7 and 8, the off-road-type data may include at least two of snow-type data (SNOW) corresponding to a snow road, sand-type data (SAND) corresponding to a sand road, and mud-type data (MUD) corresponding to a mud road. At least two of a disconnector control reference (for example, 40) of the snow-type data (SNOW), a disconnector control reference (for example, 20) of the mud-type data (MUD), and a disconnector control reference (for example, 20) of the sand-type data (SAND) may be different from each other, but the present disclosure is not limited thereto. Snow, mud, and sand may be different from each other in terms of cohesion between particles, and thus snow terrain, mud terrain, and sand terrain may be different from each other in terms of a degree of change in a level deviation of a road according to a torque of a wheel, and the snow terrain, the mud terrain, and the sand terrain may be different from each other in terms of a driving force required to prevent a vehicle from becoming stuck.

For example, a driving force required to prevent the vehicle from becoming stuck on a snow road may be smaller than a driving force required to prevent the vehicle from becoming on a mud road and/or a sand road. Accordingly, the disconnector control reference (for example, 40) of the snow-type data (SNOW) may be higher than the disconnector control reference (for example, 20) of the mud-type data (MUD) and the disconnector control reference (for example, 20) of the sand-type data (SAND). Accordingly, accuracy and reliability of control whether the disconnector is to be engaged may be further improved.

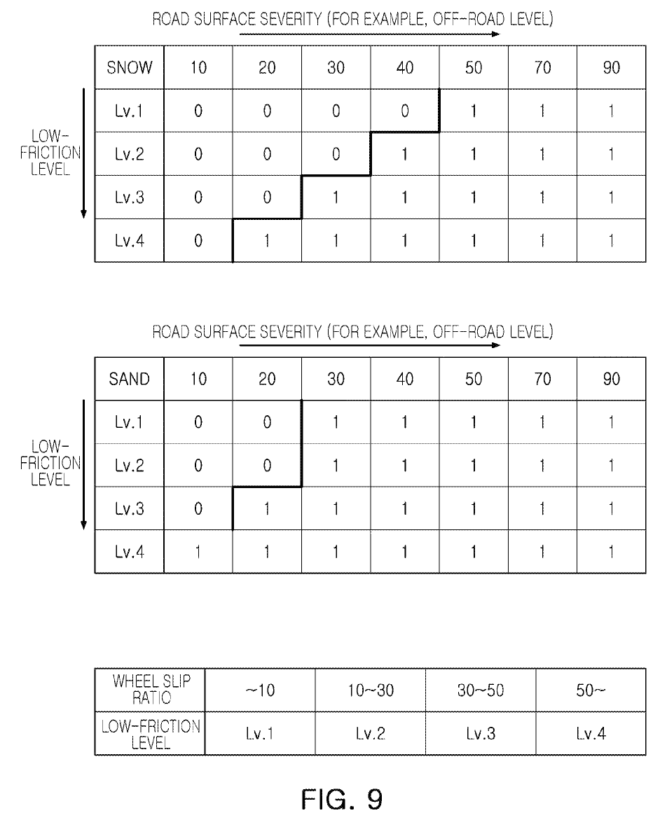

Referring to FIG. 9, the controller may store a plurality of disconnector control reference sets (for example, two-dimensional data including a low-friction level and an off-road level, one-dimensional data including a low-friction level, or one-dimensional data including an off-road level). The plurality of disconnector control reference sets may include at least two of a snow-type disconnector control reference set (SNOW), a sand-type disconnector control reference set (SAND), and a mud-type disconnector control reference set (in FIG. 9, it is assumed that disconnector control references of sand and mud are the same).

For example, the disconnector control logic may be configured to select one of the plurality of disconnector control reference sets according to the off-road-type data, and to determine whether the disconnector is to be engaged according to the low-friction level (vertical direction of the set) and the off-road level (horizontal direction of the set) in the selected disconnector control reference set.

For example, a disconnector control value of 0 may correspond to disconnector disengagement control (2WD control), a disconnector control value of 1 may correspond to disconnector engagement control (4WD control), and a boundary between the disconnector control values of 0 and 1 may correspond to a disconnector control reference. For example, when the plurality of disconnector control reference sets are N-dimensional data, the plurality of disconnector control reference sets may also be configured as a single (N+1)-dimensional disconnector control reference set.

Referring to FIGS. 7 and 9, the road surface severity may include at least one of a low-friction level (corresponding to S232) and an off-road level (corresponding to S220), and the disconnector control logic may be configured to determine whether the disconnector is to be engaged according to at least one of the low-friction level and the off-road level. Accordingly, accuracy and reliability of control whether the disconnector is to be engaged may be further improved.

The disconnector control logic may be configured to determine the disconnector control reference according to one of the low-friction level and the off-road level (for example, the low-friction level) (S232), and to allow the controller to control whether the disconnector is to be engaged according to a comparison relationship between the other one (for example, the off-road level) and the disconnector control reference (S233). Accordingly, confusion between input variables (for example, off-road-type data, low-friction level, off-road level, road surface severity) which may be used for controlling whether the disconnector is to be engaged may be preemptively prevented.

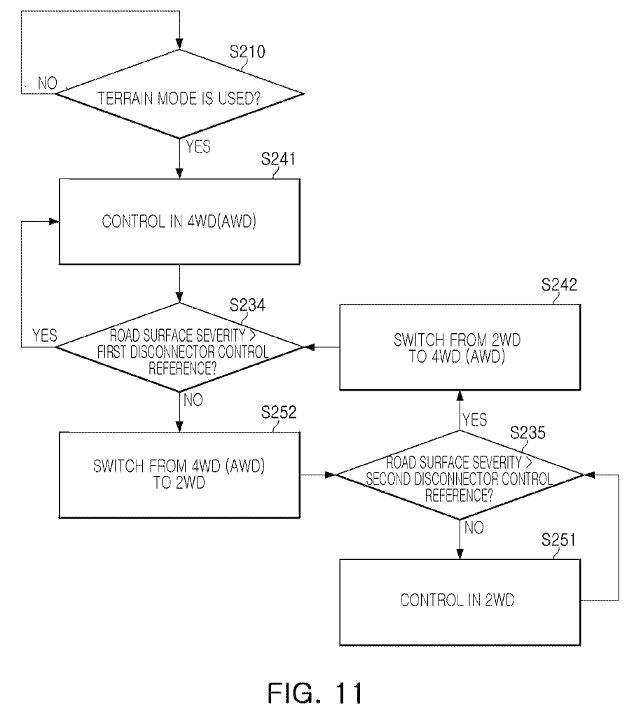

For example, assuming that the controller selects the snow-type disconnector control reference set (corresponding to S231), the disconnector control reference may be determined to be 40 to 50 when the low-friction level is Lv.1, 30 to 40 when the low-friction level is Lv.2, 20 to 30 when the low-friction level is Lv.3, and 10 to 20 when the low-friction level is Lv.4. For example, when the disconnector control reference includes a first and a second disconnector control reference (see FIG. 11), the first disconnector control reference may be 10, 20, 30, and 40, and the second disconnector control reference may be 20, 30, 40, and 50, but the present disclosure is not limited thereto.

For example, the disconnector control logic may be configured so that when the other one (for example, the off-road level) of the low-friction level and the off-road level is lower than the disconnector control reference (one of the above comparison relationships), the controller is configured to control the disconnector to be in a disengaged state to perform control in 2WD (corresponding to 0 in FIG. 9), and when the other one (for example, the off-road level) is higher than the disconnector control reference (the other one of the above comparison relationships), the controller is configured to control the disconnector to be in an engaged state to perform control in 4WD (corresponding to 1 in FIG. 9).

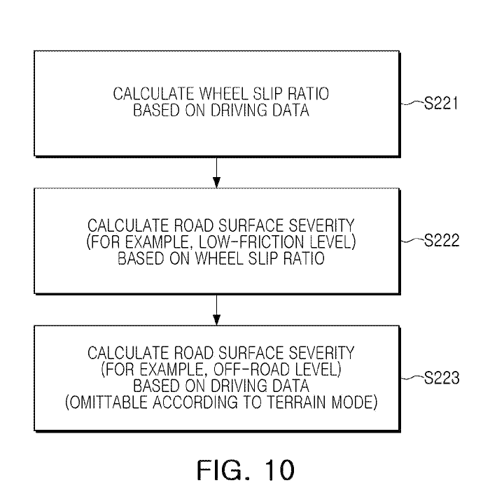

Referring to FIGS. 9 and 10, the disconnector control logic may be configured to determine a wheel slip ratio, based on the driving data (S221), to determine the low-friction level, based on the wheel slip ratio (S222), and to determine the off-road level, based on the driving data, (S223). For example, the road surface severity may include the off-road level and/or the low-friction level, and the off-road level may correspond to an automatic off-road (for example, terrain) determination value of the off-road driving mode (for example, an automatic terrain mode). The determination (S223) may include automatic off-road (for example, terrain) determination.

For example, the controller is configured to receive a speed of the vehicle (vehicle speed) and the number of rotations of the wheel (wheel speed) from a sensor unit, and may be configured to determine the wheel slip ratio by dividing a difference value between the wheel speed and the vehicle speed by the wheel speed or the vehicle speed (an additional variable and/or constant being applicable). For example, the controller may be configured to determine (determine through comparison) a wheel slip ratio range to which the determined wheel slip ratio belongs from among a plurality of wheel slip ratio ranges (~10, 10~30, 30~50, and 50~) of the low-friction levels (Lv.1, Lv.2, Lv.3, and Lv.4), determining the low-friction level.

FIG. 9 illustrates that a wheel slip ratio range of the low-friction level (Lv.4) has no upper limit. However, depending on a design thereof, the controller may define a minimum wheel slip ratio at which the vehicle may slip (for example, a value close to 100) as an upper limit of the wheel slip ratio of the low-friction level (Lv.4). Accordingly, when the wheel slip ratio is high, the controller may be configured for controlling (for example, determine the disconnector control reference to be close to 0 and control the disconnector to be in an engaged state regardless of the off-road level) the disconnector to be in an engaged state in advance through feedforward, before the vehicle actually slips, preventing degradation of vehicle stability/performance during a mechanical engagement period of time (for example, 0.5 seconds) of the disconnector.

Referring to FIG. 11, the disconnector control reference may include a first disconnector control reference and a second disconnector control reference higher than the first disconnector control reference. The disconnector control logic may be configured so that when the road surface severity is switched from a level higher than the first disconnector control reference (“Yes” in S234) to a level lower than the first disconnector (“No” in S234), the controller is configured to switch the disconnector from an engaged state (corresponding to S241) to a disengaged state to switch from 4WD (corresponding to S241) to 2WD (S252), and when the road surface severity is switched from a level lower than the second disconnector control reference (“No” in S235) to a level higher than the second disconnector control reference (“Yes” in S235), the controller is configured to switch the disconnector from a disengaged state (corresponding to S251) to an engaged state to switch from 2WD (corresponding to S251) to 4WD (AWD being possible) (S242). Accordingly, the controller may reduce the frequency of switching between the engaged and disengaged states of the disconnector based on a hysteresis principle, improving control stability of disconnector.

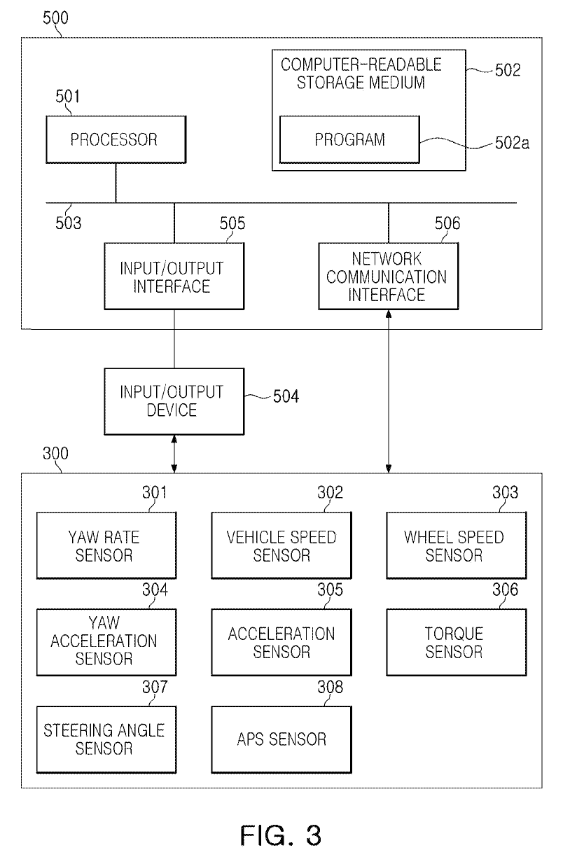

Referring to FIG. 3, the controller 500 may be implemented as a computing system including at least one processor 501, a computer-readable storage medium 502, and a communication bus 503. For example, the controller 500 may be implemented as a microcontroller or an embedded system. The storage medium 502 may record one or more programs including instructions for executing the disconnector control method for supporting driving according to an exemplary embodiment of the present disclosure. The communication bus 503 may interconnect various other components of the computing device 500, including the processor 501 and the computer-readable storage medium 502.

The processor 501 may cause the computing device 500 to operate according to the example embodiments described above. For example, the processor 501 may execute one or more programs stored in the computer-readable storage medium 502. The one or more programs may include one or more computer-executable instructions. When executed by the processor 501, the one or more computer-executable instructions may be configured to cause the computing device 500 to perform operations according to example embodiments.

The computer-readable storage medium 502 may be configured to store the computer-executable instructions or program code, program data, and/or other suitable forms of information. A program 502a, stored in the computer-readable storage medium 502, may include a set of instructions executable by the processor 501. In an example embodiment, the computer-readable storage medium 502 may be a memory (a volatile memory such as a random access memory, a non-volatile memory, or any suitable combination thereof), one or more magnetic disk storage devices, optical disk storage devices, flash memory devices, other types of storage media that are accessible by the computing device 500 and are configured for storing target information, or any suitable combinations thereof.

The computing device 500 may also include one or more input/output interfaces 505 providing an interface for one or more input/output devices 504, and one or more network communication interfaces 506. The input/output interface 505 and the network communication interface 506 may be connected to the communication bus 503. A network may be one of a cellular network, such as global system for mobile communications (GSM), enhanced data rates for GSM evolution (EDGE), general packet radio service (GPRS), Code Division Multiple Access (CDMA), time division-CDMA (TD-CDMA), Universal Mobile Telecommunications System (UMTS), or long-term evolution (LTE), or another cellular network, and may be implemented as Ethernet, media-oriented systems transport (MOST), Flexray, Controller Area Network (CAN), Local Interconnect Network (LIN), Internet, Bluetooth, Near Field Communication (NFC), Zigbee®, radio frequency (RF), or the like.

The input/output device 504 may be connected to other components of the computing device 500 through the input/output interface 505. The exemplary input/output device 504 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 504 may be included in the computing device 500 as a component included in the computing device 500, or may be connected to the computing device 500 as a device, distinct from the computing device 500.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the exemplary embodiments of the present disclosure, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code which may be executed by the computer using an interpreter.

According to an exemplary embodiment of the present disclosure, a disconnector control apparatus and method for supporting driving, and a vehicle and storage medium including the same, may efficiently improve overall driving energy efficiency on a road surface, and may stably secure driving force (and/or secure additional stability according to AWD control), even when road surface severity of the road surface varies widely, efficiently reducing a possibility of a vehicle slipping and/or becoming stuck.

For example, whether a disconnector is to be engaged may be controlled in advance through feedforward, before a vehicle actually slips or becomes stuck so that whether the disconnector is to be engaged may be controlled earlier to prevent degradation in vehicle stability and/or performance during a mechanical engagement period of time (for example, 0.5 seconds) of the disconnector.

While example embodiments have been shown and described above, it will be apparent to those skilled in the art that modifications and variations could be made without departing from the scope of the present disclosure as defined by the appended claims.

What is claimed is:

1. A disconnector control apparatus for supporting driving, the disconnector control apparatus comprising:
a controller configured to receive driving data of a vehicle configured to switch between two-wheel drive (2WD) and four-wheel drive (4WD) depending on whether a disconnector is engaged, and to control whether the disconnector of the vehicle is to be engaged according to disconnector control data obtained by applying the driving data to a disconnector control logic;
wherein the disconnector control logic is configured to determine whether the disconnector is to be engaged according to road surface severity of a road surface of the vehicle based on the driving data.

2. The disconnector control apparatus of claim 1, wherein the disconnector control logic is further configured so that based on that the road surface severity is less than a disconnector control reference, the controller controls the disconnector to be in a disengaged state to perform control in the 2WD, and based on that the road surface severity is more than the disconnector control reference, the controller controls the disconnector to be in an engaged state to perform control in the 4WD.

3. The disconnector control apparatus of claim 2,
wherein the disconnector control reference includes a first disconnector control reference and a second disconnector control reference higher than the first disconnector control reference, and
wherein the disconnector control logic is further configured so that based on that the road surface severity is switched from a level higher than the first disconnector control reference to a level lower than the first disconnector control reference, the controller switches the disconnector from the engaged state to the disengaged state to switch from the 4WD to the 2WD, and based on that the road surface severity is switched from a level lower than the second disconnector control reference to a level higher than the second disconnector control reference, the controller switches the disconnector from the disengaged state to the engaged state to switch from the 2WD to the 4WD.

4. The disconnector control apparatus of claim 2,
wherein the road surface severity includes at least one of a low-friction level of the road surface or an off-road level of the road surface, and
wherein the disconnector control logic is further configured to determine whether the disconnector is to be engaged according to at least one of the low-friction level or the off-road level.

5. The disconnector control apparatus of claim 4, wherein the disconnector control logic is further configured to determine the disconnector control reference according to one of the low-friction level and the off-road level, and to allow the controller to control whether the disconnector is to be engaged according to a comparison relationship between the other one of the low-friction level and the off-road level and the disconnector control reference.

6. The disconnector control apparatus of claim 4, wherein the disconnector control logic is further configured to determine a wheel slip ratio, based on the driving data, to determine the low-friction level, based on the wheel slip ratio, and to determine the off-road level, based on the driving data.

7. The disconnector control apparatus of claim 4,
wherein the controller is configured to define off-road-type data of the vehicle,
wherein the off-road-type data includes at least two of snow-type data corresponding to a snow road, sand-type data corresponding to a sand road, or mud-type data corresponding to a mud road,
wherein the controller is configured to store a plurality of disconnector control reference sets,
wherein the plurality of disconnector control reference sets include at least two of a snow-type disconnector control reference set, a sand-type disconnector control reference set, or a mud-type disconnector control reference set, and
wherein the disconnector control logic is further configured to select one of the plurality of disconnector control reference sets according to the off-road-type data, and to determine whether the disconnector is to be engaged according to the low-friction level and the off-road level in the selected disconnector control reference set.

8. The disconnector control apparatus of claim 1,
wherein the controller is configured to define off-road-type data of the vehicle, and
wherein the disconnector control logic is further configured to determine whether the disconnector is to be engaged according to the off-road-type data and the road surface severity.

9. The disconnector control apparatus of claim 1,
wherein the controller is configured to receive the driving data from a sensor unit, and
wherein the driving data includes at least one of a speed of the vehicle, an acceleration of the vehicle, a yaw rate of the vehicle, a yaw acceleration of the vehicle, a steering angle of the vehicle, a number of rotations of a wheel of the vehicle, a torque of the vehicle, or an acceleration input value of the vehicle.

10. The disconnector control apparatus of claim 9,
wherein the disconnector control logic is further configured to periodically determine whether the disconnector is to be engaged at a predetermined determination cycle, and
wherein the predetermined determination cycle is less than 10 seconds.

11. The disconnector control apparatus of claim 9,
wherein the disconnector control logic is further configured to selectively control whether the disconnector is to be engaged depending on whether an off-road driving mode is used, and
wherein the controller is configured to determine whether the off-road driving mode is used based on a manual method according to an input or an automatic method based on the driving data.

12. A disconnector control method for supporting driving, the disconnector control method comprising:
storing a disconnector control logic of a vehicle based on road surface severity of a road surface of the vehicle configured to switch between two-wheel drive (2WD) and four-wheel drive (4WD) depending on whether a disconnector is engaged;
receiving, by a controller, driving data of the vehicle; and
applying, by the controller, the driving data to the disconnector control logic to control whether the disconnector of the vehicle is to be engaged.

13. The disconnector control method of claim 12,
wherein the road surface severity includes at least one of a low-friction level of the road surface or an off-road level of the road surface, and
wherein the disconnector control method further comprises:
determining, by the disconnector control logic, whether the disconnector is to be engaged according to at least one of the low-friction level or the off-road level.

14. The disconnector control method of claim 13, further comprising:
determining, by the disconnector control logic, a disconnector control reference according to one of the low-friction level or the off-road level;
controlling, by the disconnector control logic, the disconnector to be in a disengaged state based on that the other one of the low-friction level or the off-road level is lower than the disconnector control reference; and
controlling, by the disconnector control logic, the disconnector to be in an engaged state based on that the other one of the low-friction level or the off-road level is higher than the disconnector control reference.

15. The disconnector control method of claim 12, further comprising:
determining, by the disconnector control logic, whether the disconnector is to be engaged according to an off-road-type data and the road surface severity.

16. A storage medium having recorded thereon one or more programs including instructions for executing the disconnector control method for supporting driving of claim 12.

17. A vehicle comprising:
a controller including a processor and a storage medium having recorded thereon one or more programs configured to be executed by the processor,
wherein the one or more programs include instructions for executing the disconnector control method for supporting the driving of claim 12.

18. A vehicle comprising:
a disconnector configured to switch between two-wheel drive (2WD) and four-wheel drive (4WD) depending on whether the disconnector is engaged;
a sensor unit configured to detect driving data; and
a controller configured to control whether the disconnector is to be engaged according to disconnector control data obtained by applying the driving data to a disconnector control logic,
wherein the disconnector control logic is configured to determine whether the disconnector is to be engaged according to road surface severity of a road surface of the vehicle based on the driving data.

19. The vehicle of claim 18,
wherein the road surface severity includes at least one of a low-friction level of the road surface or an off-road level of the road surface, and
wherein the disconnector control logic is further configured to determine whether the disconnector is to be engaged according to at least one of the low-friction level or the off-road level.

20. The vehicle of claim 19, wherein the disconnector control logic is further configured to:
determine a disconnector control reference according to one of the low-friction level or the off-road level;
control the disconnector to be in a disengaged state based on that the other one of the low-friction level or the off-road level is lower than the disconnector control reference; and
control the disconnector to be in an engaged state based on that the other one of the low-friction level or the off-road level is higher than the disconnector control reference.
